(19) United States
(12) Patent Application Publication
(10) Pub. No.: US 2008/0222251 A1
(43) Pub. Date: Sep. 11, 2008

(54) Adaptive framework for the flow of medical device data in the personal health space

(76) Inventor: Jayant Parthasarathy, Eden Prairie, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 12/006,741

(22) Filed: Jan. 3, 2008

Related U.S. Application Data
(60) Provisional application No. 60/878,571, filed on Jan. 3, 2007.

(51) Int. Cl. G06F 15/16

(52) U.S. Cl. 709/205

(57) ABSTRACT

A system and method which permits adaptive configuration of a Manager Device in response to an Agent Device in a personal health space. The Manager Device is able to configure itself in response to queries to and from the Agent Device. This configuration can based on the level of complexity of the Agent Device. The Agent Device can vary between a Standard framework and an Advanced framework. The communication between the two devices occurs over a wired or wireless connection.

### RELATED APPLICATIONS

This application claims priority under 35 U.S.C. 119(e) from provisional U.S. Patent Application No. 60/878,571, filed Jan. 3, 2007, the contents of which are incorporated herein by reference.

### BACKGROUND OF THE INVENTION

The present invention relates to data communication, and more particularly to medical-related data communicated between a pair of devices within a personal health space.

### BRIEF SUMMARY OF THE INVENTION

The present invention is directed to a system and method that permits adaptive configuration of a Manager device in response to an Agent device within a personal health space. The Manager Device is able to configure itself in response to queries to and from the Agent Device. This configuration can be based on the level of complexity of the Agent Device. The Agent Device can vary between a standard framework and an advanced framework. The communication between the Manager Device and the Agent Device occurs over a wired or wireless connection.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating a system according to one embodiment;

FIG. 2 is a flow chart illustrating a data flow according to one embodiment;

FIG. 3 is an interaction diagram between a Standard Pulse Ox and a Manager Device

FIG. 4 is an interaction diagram between an Advanced Pulse Ox and a Manager Device

### DETAILED DESCRIPTION OF THE INVENTION

Before discussing in detail the architecture of the present invention, it is useful to describe the general operating environment of personal health (PH) devices as well as the subtle differences between data flow in a clinical space versus a personal health space. For ease of comparison, the data flow can be split into medical data, such as data required to make a medical diagnosis (e.g. Pulse Rate, Systolic Pressure, device accuracy, device resolution etc) and association meta-data, such as messaging wrappers around the medical data (e.g. Get/Set Messaging, Device capabilities/Attributes etc)

Clinical Medical Data v/s PH Medical Data

Care providers generally do not want to differentiate the medical aspect of the data. Specifically the care providers generally do not need to differentiate whether this data was acquired at home, in a clinic, a hospital or any other location. The care providers generally desire that the quality, reliability, security and the nomenclature of the medical data collected is the same in order to allow effective diagnosis and inter-operability of the data and devices.

Clinical Association Meta-Data v/s PH Association Meta-Data

In a clinical environment, an Agent Device (e.g. Pulse Oximeter) is frequently used between different rooms and/or patients. Data acquired by the Agent Device may be displayed on several different Manager Devices (e.g. Vital Sign Monitor) as the Agent Device changes between rooms and patients.

In order for these devices to inter-operate in the environment where their usage extends to several different applications and patient conditions, some “artificial intelligence” is provided in the Agent Device and the Manager Device. A goal of this intelligence is to ensure that every time a link or other connection is set-up between the Agent Device and the Manager Device, the devices properly identify themselves. In some embodiments, as required by an application, the devices can accordingly re-configure themselves to transmit the appropriate data. However, an Agent Device in the PH space would likely communicate to a very small list of Manager Devices (e.g. Home PC, Set-top Box, Cell-phone, etc) at the patient's home, and thus have limited need for re-configurability. Agent Device used in the PH space can be relatively simple, as compared to Agent Device in the clinical environment. Once an Agent Device introduces itself to the Manager Device for all subsequent sessions all it needs to do is transmit data when polled.

It should be noted that in the clinical setting, the devices are generally handled and serviced by trained and competent professionals. Whereas in the PH space, it is desirable that the devices be simple enough to be used by patients or others with limited training and cognitive abilities.

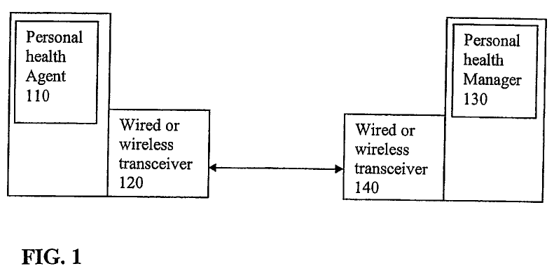

FIG. 1 is a block diagram illustrating an environment in which aspects of present invention can be implemented. System 100 includes a personal health Agent Device 110, a wired or wireless transceiver 120, a Manager Device 130 and a second wired or wireless transceiver 140. While this discussion refers to a single Agent Device 110 and a single Manager Device 130, those skilled in the art will readily recognize that the present invention can be implemented using more than one Agent Device 110 or Manager Device 130.

Personal health Agent Device 110 is in one embodiment a pulse oximeter. However, other devices can be used such as a thermometer, blood pressure monitor, electrocardiogram (EKG), electroencephalogram (EEG), a weight scale, or any other physiological and activity monitoring device suitable for humans or animals. However, some embodiments, the personal health Agent Device 110 can be configured to provide certain medical treatments to the patient, such as permitting or controlling the flow of intravenous drugs. As described above, the PH Agent Device 110 may be a relatively simple device that requires a minimal amount of structure or operational overhead to perform the desired functions to communicate with the Manager Device 130. The specific components of the PH Agent Device 110 will vary depending on the functionality of the Agent Device 110.

Operation of the personal health Agent Device 110 can be divided into two different frameworks, Standard and Advanced. In the standard framework, the Agent Device 110 is capable of communicating a minimum set of data at a predetermined format. For example, a weight scale configured to communicate weight in kgs and lbs.

In the Advanced framework, the Agent Device 110 is configured to transmit, in addition to the minimum set of data, additional data that can, for example, differentiate the Agent Devices 110. In one example, Agent Device 110 is configured to self-describe its attributes to the Manager Device 130. In some embodiments this identification can be done using a global unique identifier (GUID) or can be done using a hierarchal approach. However, other methods of identification can be used. In some embodiments the Agent Device 110 is configured with advance functionality. For example, the weight scale can be configured to communicate to Manager Device 130 determined weight data in kgs and lbs as well as body fat percentage data.

The Manager Device 130 processes signals from the Agent Device 110. In one embodiment the Manager Device 130 is a personal computer. However, in other embodiments the Manager Device 130 can be a cell phone, a set top box, a personal digital assistant, or any other device that can process, display, or forward to an upstream device the information from the Agent Device 110. The Manager Device 130 receives information from Agent Device 110 and, in one example, converts that information into a readable display that may be read by medical personnel. However, in other embodiments the Manager Device 130 converts the received information into a protocol that is then sent to a remote site where the data can be reviewed. Additionally in some embodiments, the Manager Device 130 is configured to handle information from an Agent Device 110 operation in either the Standard framework or the Advanced framework.

Transceiver devices are utilized to communicate between the Agent Device 110 and the Manager Device 130. Agent Device 110 has a transceiver 120 and Manager Device 130 has a transceiver 140. While the present discussion refers to transceivers 120 and 140, those skilled in the art will recognize that these could be transmitters, receivers, or any combination thereof. The transceivers 120 and 140 can make use of any known wireless or wired protocol. For example, the transceivers 120 and 140 can use Bluetooth, IR, IEEE 802.11, GPRS, GSM, WMTS, IEEE 802.15.4 (ZigBee), USB, or any other protocol to transmit data between the Agent Device 110 and the Manager Device 130.

Advantages of the above-described framework include use of standard nomenclature, self-description of device formats and capabilities, streaming, episodic and batch transfer modes, and low overhead.

As described above, the Agent Device 110 can, in some embodiments, operate within a Standard framework or an Advanced framework. For purposes of the following discussion, the Agent Device 110 is a pulse oximeter capable of determining the oxygenation level of blood in a person or animal. In the Standard framework the pulse oximeter provides streaming as well as episodic SpO₂ and pulse rate data. In the Advanced framework the pulse oximeter provides streaming as well as episodic SpO₂, pulse rate data, and other metrics such as pulse quality, beat to beat average or other metrics.

In the Standard framework, prior to transmitting data between the Agent Device 110 and Manager Device 130, a data flow interaction is defined. In order to set up the data flow interaction, the Agent Device 110 and the Manager Device 130 set up an initial connection. After this connection has been made, both devices 110 and 130 provide a connection indication and if required, exchange their Global Unique Identifiers (GUID) or other identification means. Once the connection has been set up and the ID's have been exchanged, the Manager Device 130 requests classification information from the Agent Device 110. As the Agent Device 110 is operating in the Standard framework, it replies with its device classification, such as Standard pulse oximeter. The Manager Device 130 then checks to see if the associated nomenclature and syntax are available for a Standard pulse oximeter. Once this check has been completed, the Manager Device 130 sends to the pulse oximeter 110 a directive to send its payload data. A series of negotiations or other communications protocol occurs at this time including Quality of Service (QoS) negotiations. Upon completion of the additional negotiations, the Agent Device 110 and Manager Device 130 are both ready to transmit and receive payload data. After the Agent Device 110 has generated the payload data, the Agent Device 110 transmits the data payload to the Manager Device 130. The Manager Device 130 then processes this data and performs any other necessary operations. In the event of an intentional or unintentional disconnection of the device, which can occur for a variety of reasons, the Agent Device and Manager Device attempt to reconnect to each other. During the reconnection, the devices again exchange their identifications. Following the re-identification and a check to see that the connection is satisfactory, the Agent Device 110 resends or attempts to send a default payload back to the Manager Device 130.

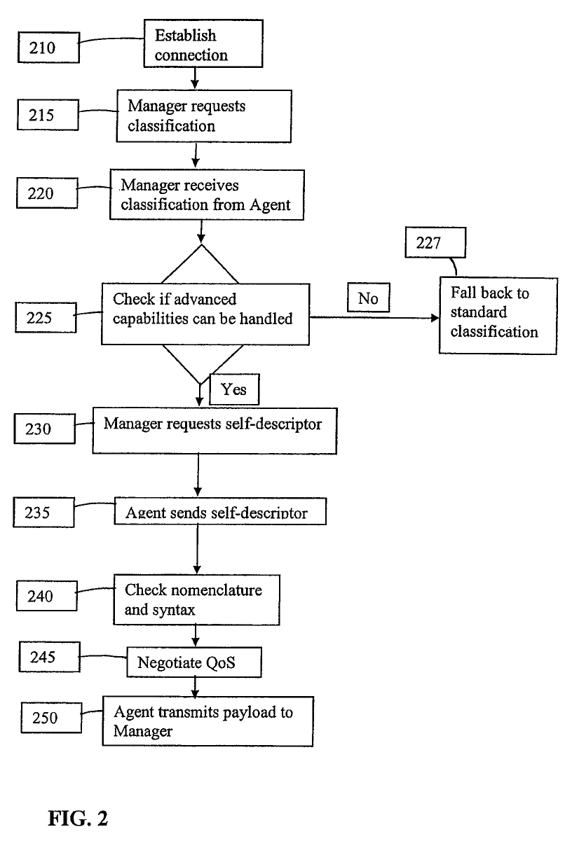

The Advanced framework sets up a connection in a similar fashion as in the Standard framework. However, for purposes of completeness the process will be repeated again. For clearer reference to the process, FIG. 2 is a flow diagram illustrating the steps executed during connection and data flow in the Advanced framework, according to one embodiment. At step 210 the transport layer sets-up the connection between the Agent Device and the Manager Device and provides a connect indication to both devices. At this step it also conveys to both devices 110 and 130 each others GUID (e.g. Bluetooth MAC address, etc)

At step 215 the Manager Device 130 requests the Agent Device's classification. If the Agent Device 110 supports other physiological types, such as blood pressure, then the classification would accordingly indicate if the Blood Pressure is Standard or Advanced along with streaming or episodic. The Agent Device 110 replies back with its classification list at step 220.

The Manager Device 130 checks to see if it is capable of parsing and processing the Agent Device's 110 capabilities. This is illustrated at step 225. If the Manager Device 130 is capable of interpreting the Advanced features, then Manager Device 130 requests the self-descriptor from the Agent Device 110 for a particular data-set (in this example extended payload P1), at step 230. The Agent Device 110 replies with its self-descriptor for payload P1. The self-descriptor describes payload format, the metrics embedded within the payload format, and any supporting information about each particular metric. This is illustrated at step 235.

The Manager Device 130 reviews the self-descriptor to make sure the syntax and nomenclature are in compliance. An application residing in the Manager Device 130 subsequently directs the Agent Device 110 as to which payload (in this case payload P1 is desired), and specifies the Quality of Service (hereinafter “QoS”) it needs for the application. This is illustrated at step 240.

The Agent Device 110 and the Manager Device negotiate acceptable QoS. This is illustrated at step 245.

The Agent Device 110 proceeds to transmit Payload P1 until a stop request is made. This is illustrated at step 250. If there is an intentional or un-intentional drop in connection the wired or wireless transport protocol is responsible for re-initiating the link. Once the link is set-up, the Agent Device and Manager Device recognize that they were previously connected (based on the GUIDs) without resending the Self-descriptor again. The Agent Device 110 then proceeds to transmit the default payload back to the Manager Device 130. In some embodiments, a different payload, for example payload P2, can be sent by Agent Device 110 in response to a signal received from Manager Device 130.

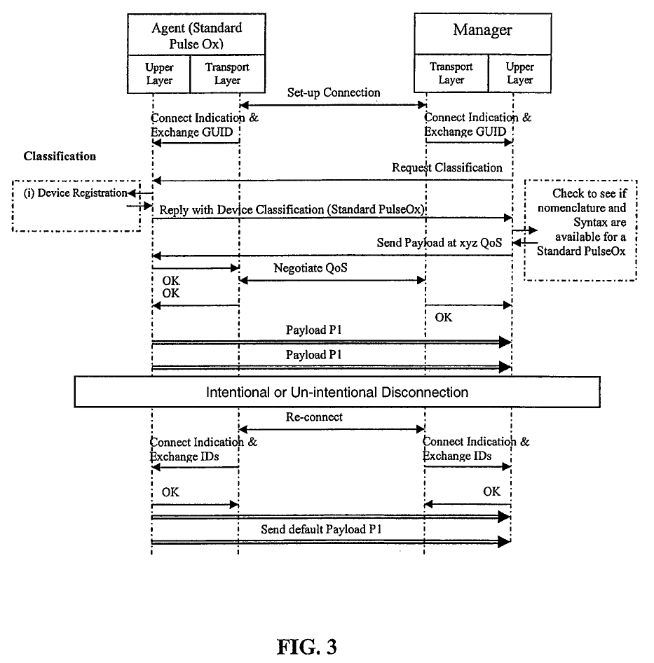

FIG. 3 illustrates interactions between a Standard Agent Device 110 (Pulse Oximeter) and a Manager Device 130.

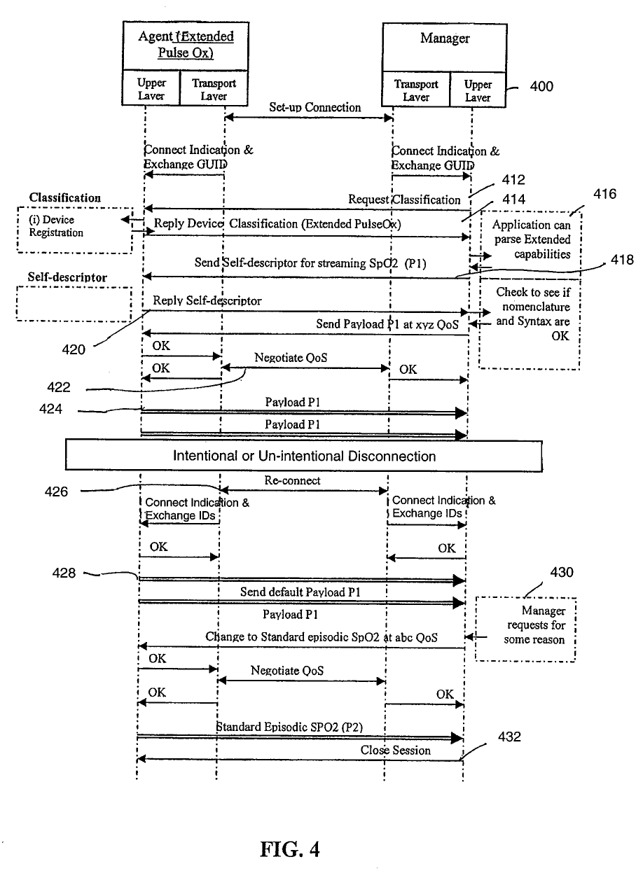

FIG. 4 illustrates interactions between an Advanced Agent Device 110 (Pulse Oximeter) and a Manager Device 130 to transfer SpO2 data.

The transport layer 400 sets-up the connection between the Agent Device 110 and the Manager Device 130 and provides a Connect Indication to both devices. It also conveys to both devices each others Globally unique IDs (E.g. Bluetooth MAC address, etc)

The Manager Device 130 requests the Agent Device's classification at step 412. If the device supports other physiological types, say Blood Pressure, then the classification would accordingly indicate if the BP is standard or Advanced along with streaming or episodic The Agent Device 110 replies back with its classification at step 414. The Manager Device 130 checks to see if it is capable of parsing advance capabilities at step 416. If indeed so, then Manager Device 130 requests the self-descriptor for a particular data-set (in this example streaming payload P1) at step 418. Agent Device 110 replies with its Self-descriptor for P1 at step 420. Self-descriptor describes payload format and metrics. Manager Device 130 reviews the Self-descriptor to make sure the syntax and nomenclature are in compliance. An application residing in the Manager Device specifies the QoS it needs for the application. The Agent and Manager Devices negotiate acceptable QoS at step 422. At step 424, the Agent Device 110 proceeds to transmit Payload P1 until requested to stop doing so.

If there is an intentional or un-intentional drop in connection—the Transport layer is responsible for re-initiating the link and providing the Connect Indication. Once the link is set-up, the Agent 110 and Manager 130 now reconnect at step 426 that they were previously connected (based on the Transport IDs)—so, without resending the Self-descriptor again, Agent proceeds to transmit the default payload at step 428.

As depicted at step 430, if the Manager Device at any point wants to change the data it has requested, it can choose to send another request. The session is closed at step 432.

In order to optimize adaptive aspects of the invention, in one example the Manager Devices 130 recognize and interpret data communicated by the Standard Agent Devices without the need for “drivers” or self-description. Advanced Agent Devices 110 would need to self-describe their capabilities and especially the differences from the Standard device format. The Manager Devices 130 can also be classified as Standard and Advanced. Standard Manager Devices have limited intelligence and can only communicate with the Standard capabilities in the Agent Devices. Advanced Manager Devices have the choice to go above and beyond the capabilities of the Standard Manager Devices, facilitating device differentiation, enhancements and promoting innovation. Table 1 provides a brief breakdown of the differences between Standard and Advanced Agent Devices and Manager Devices.

TABLE 1

| | Standard Agent Devices | Advanced Agent Devices |
|---|---|---|
| Standard Manager | Interactions restricted to | Interactions restricted |
| Devices | Standard payloads | to Standard payloads |
| Advanced Manager | Interactions restricted to | Interactions can be of |
| Devices | Standard payloads | Standard or Advanced |
| | | payload types. |

In some embodiments Standard payloads are supported by Standard Agent Devices 110 and rely on device/data specialization to specify the data (e.g. SpO2, Pulse Rate in a Pulse Ox) and the format of the payload structure. In other embodiments, Advanced payloads are payloads in addition to the Standard payloads and are supported by self-descriptors that would allow Manager Devices 130 to parse the information.

Referring now back to the Standard framework Agent Device 110, the streaming attributes for the Agent Device will now be discussed. As the Standard capabilities of Agent Device 110 are known to the Manager Device 130, it is not necessary that the Agent Device 110 self-describe its capabilities during the connection process. As it is not necessary for a device to provide a description of itself to the Manager Device 130, a detailed listing of measurement characteristics can be provided in a device specialization file. Table 2 is an example, according to one embodiment, outlining some of the data that can be provided by a pulse oximeter Agent Device 110.

TABLE 2

| | | | |
|---|---|---|---|
| SpO2HiByte | SpO2LoByte | PlethyHiByte | PlethyLoByte |
| PulseRateHiByte | PulseRateLoByte | PlethyHiByte | PlethyLoByte |
| Pulse- | PulseAmplitudeLo | . . . | |
| AmplitudeLo | | | |
| AlarmsHi | AlarmsLo | . . . | |
| StatusHi | StatusLo | . . . | |

Referring now back to the Advanced framework, an Agent Device 110 with Advanced capabilities transmits both its capabilities as well as its transmission protocol or other attributes before any payload is sent.

In an Advanced Agent Device 110 the self-descriptor may be described as a series of tables, making use of standardized nomenclature (e.g. ISO/IEEE 11073-10101 nomenclature), with extensions pertinent to a broader range of pulse oximeters, and capabilities such as time-synchronized event reporting. However, other approaches can be used. The self-descriptor can be sent from the Agent Device 110 to the Manager Device 130 in order for the Manager Device 130 to determine how to process the subsequent data stream.

In one embodiment the self-descriptor includes, a device description (in terms of its model, number of channels, QoS capabilities, etc), and a payload description inclusive of size, location or other information.

One advantage of the self-descriptor is that it can be implemented as a “static patch”. A static patch basically introduces the device and its capabilities. In one example, the self-descriptor is sent only when the Advanced Agent Device 110 introduces itself to the Manager Device 130 for the first time (or until specifically asked for). It could be easily ported to XML or other Standardized description protocol.

The following tables propose self-description attributes to be sent as a description message. Not currently defined or unresolved nomenclature is italicized in these tables. These tables describe most of the medical data attributes of an exemplary pulse oximeter that is similar to products currently used. Some of the tables are provided to give an example of the data needed to describe a particular oximeter. Note that the format is similar to the material in ISO/IEEE 11073-10201 (Domain Information Model) and ISO/IEEE 11073-10101 (Nomenclature), but the contents are not necessarily intended to fully fit within a particular model under discussion. To limit the scope of this discussion, these attributes are applicable for a streaming payload and an episodic payload type, Payloads P1 and P2 are provided as examples.

### Attributes for Streaming SpO2—Primary

Table 3 describes the attribute for reporting an oximeter's most widely used oxygen saturation measurement. Each metric must have a specification attached to it, and attribute keys usually have an associated value. In this case the specification key is the mnemonic MDC_ATTR_METRIC_SPECN, and its associated value is MDC_METRIC_O2_SAT_NORM. Note that this mnemonic value would be an extension of current nomenclature. The next attribute relates to the location of the particular element in the data payload. Refer to the Payload Format discussed below for more details. Note that it is implicit within this Metric that the Metric Type is described as a two-byte integer/fractional value pair, where the first byte is the integer portion, and the second byte is the fractional portion, expressed as tenths. Implicitly describing the data type by the Specification allows the size of the list to be smaller. In addition, any established attributes for Standard data types could be substituted in this table. The final element implicitly described is a modification of the established MDC_ATTR_TIME_PD_AVG attribute, which describes the time interval used in computing an average value. If another averaging formula needs to be expressed, the attribute could be included, at the penalty of a larger attribute table.

Table 3 is the primary expression of SpO₂. If the Metric Specification implicitly describes the data size, type, and averaging method, the table can be smaller in size. Note also that a repeat interval is not applicable, so a default value is considered 0, and is not included unless necessary.

TABLE 3
Metric for O2_SAT_NORM - Table descriptor size: 7 bytes

| Attribute Name | Attribute ID | Type | Remark | Qual | Example Value |
|---|---|---|---|---|---|
| Metric | MDC_ATTR_METRIC_SPECN | | Describes | M | MDC_METRIC_O2_SAT_NORM |
| Specification | | | primary | | |
| | | | expression of | | |
| | | | SpO₂ | | |
| Metric | MDC_ATTR_METRIC_DATALOCN | | Byte offset in | M | 33 |
| Location | | | data block this | | |
| | | | is located | | |

### Attributes for Streaming SpO₂—Slow-Acting

This second metric describes the SpO₂ calculation applicable for use in situations where it is advantageous to suppress quick changes in SpO₂. Note the byte position changes. Again, the MDC_METRIC_O2_SAT_LONG specification is used to implicitly describe the data type and computation method.

TABLE 4
Metric for O2_SAT_LONG - Table descriptor size: 7 bytes

| Attribute Name | Attribute ID | Type | Remark | Qual | Example Value |
|---|---|---|---|---|---|
| Metric | MDC_ATTR_METRIC_SPECN | | Describes slow- | M | MDC_METRIC_O2_SAT_LONG |
| Specification | | | acting SpO₂ | | |
| Metric Location | MDC_ATTR_METRIC_DATALOCN | | Byte offset in | M | 38 |
| | | | data block this | | |
| | | | is located | | |

### Attributes for Streaming SpO2—Fast-Acting

Yet another measurement method of SpO₂ allows for extremely rapid changes in SpO₂ to be expressed. This and subsequent tables assume that measurement information is implicit in the Metric specification value. It is worth noting in this table that additional (and optional) key=value pairs are included here pertaining to data size and data type. These are shown as an example of how a specification can have default key/value pairs overridden by explicit attributes.

TABLE 4
Metric for O2_SAT_FAST - Table descriptor size = 19 bytes

| Attribute Name | Attribute ID | Type | Remark | Qual | Example Value |
|---|---|---|---|---|---|
| Metric | MDC_ATTR_METRIC_SPECN | | Describes SpO₂ | M | MDC_METRIC_O2_SAT_FAST |
| Specification | | | intended to | | |
| | | | report rapid | | |
| | | | changes in | | |
| | | | SpO₂ | | |
| Metric | MDC_ATTR_METRIC_DATALOCN | | Byte offset in | M | 43 |
| Location | | | data block this | | |
| | | | is located | | |
| Metric Size | MDC_ATTR_METRIC_DATASIZE | | | O | 1 |
| Metric Type | MDC_ATTR_METRIC_DATATYPE | | | O | MDC_TYPE_UCHAR |
| Metric Repeat | MDC_ATTR_METRIC_DATARPTINTVL | | How often | O | 0 |
| Interval | | | attribute is | | |
| | | | repeated in | | |
| | | | block | | |
| Averaging | MDC_ATTR_BEAT_PD_AVG | | Averaging is | M | 3 |
| method | | | done on some | | |
| | | | basis | | |

### Attributes for Streaming SpO₂—Beat-to-Beat (Not Filtered)

To express the case where no additional computation is used, table 5 can be sent.

TABLE 5
Metric for O2_SAT_B2B - Table size = 7 bytes

| Attribute Name | Attribute ID | Type | Remark | Qual | Example Value |
|---|---|---|---|---|---|
| Metric | MDC_ATTR_METRIC_SPECN | | Describes SpO₂ | M | MDC_METRIC_O2_SAT_B2B |
| Specification | | | with no | | |
| | | | filtering used | | |
| | | | in computation | | |
| Metric Location | MDC_ATTR_METRIC_DATALOCN | | Byte offset in | M | 68 |
| | | | data block this | | |
| | | | is located | | |

### Attributes for Streaming SpO₂—Primary but Suitable for Display

SpO₂ should be displayed in such a way as to be readable. The final attribute, Metric Update Interval is presented to tell the Manager Device 130 that the oximeter updates this value with a predetermined periodicity.

TABLE 7
Metric for O2_SAT_DISPLAYED_N - Table size 7 bytes

| Attribute Name | Attribute ID | Type | Remark | Qual | Example Value |
|---|---|---|---|---|---|
| Metric | MDC_ATTR_METRIC_SPECN | | Describes | M | MDC_METRIC_O2_SAT_DISP_N |
| Specification | | | primary SpO₂ | | |
| | | | suitable for | | |
| | | | display | | |
| Metric | MDC_ATTR_METRIC_DATALOCN | | Byte offset in | M | 63 |
| Location | | | data block this | | |
| | | | is located | | |

### Attributes for Streaming SpO₂—Slow-Acting but Suitable for Display

Similarly, slow-acting SpO₂ suitable for display can be displayed as such.

TABLE 8
Metric for O2_SAT_DISP_L: Table size = 7 bytes

| Attribute Name | Attribute ID | Type | Remark | Qual | Example Value |
|---|---|---|---|---|---|
| Metric | MDC_ATTR_METRIC_SPECN | | Describes slow- | M | MDC_METRIC_O2_SAT_DISP_L |
| Specification | | | acting SpO₂ | | |
| | | | suitable for | | |
| | | | display | | |
| Metric | MDC_ATTR_METRIC_DATALOCN | | Byte offset in | M | 64 |
| Location | | | data block this | | |
| | | | is located | | |

### Attributes for Streaming Pulse Rate—Primary

Pulse rates are measured and displayed several ways, and the following four tables (Tables 9-12) are analogous to the SpO₂ measurements:

TABLE 9
Metric for PULSERATE_N - Table size = 7 bytes

| Attribute Name | Attribute ID | Type | Remark | Qual | Example Value |
|---|---|---|---|---|---|
| Metric | MDC_ATTR_METRIC_SPECN | | Describes | M | MDC_METRIC_PULSERATE_N |
| Specification | | | primary | | |
| | | | Pulse Rate | | |
| Metric | MDC_ATTR_METRIC_DATALOCN | | | M | 73 |
| Location | | | | | |

### Attributes for Streaming Pulse Rate—Slow-Acting

TABLE 10
Metric for PULSERATE_L - Table size = 7 bytes

| Attribute Name | Attribute ID | Type | Remark | Qual | Example Value |
|---|---|---|---|---|---|
| Metric | MDC_ATTR_METRIC_SPECN | | Describes Pulse | M | MDC_METRIC_PULSERATE_L |
| Specification | | | Rate that is | | |
| | | | slow-acting | | |
| Metric | MDC_ATTR_METRIC_DATALOCN | | Byte offset in | M | 78 |
| Location | | | data block this | | |
| | | | is located | | |

### Attributes for Streaming Pulse Rate—Primary but Suitable for Display Purposes

TABLE 11
Metric for PULSERATE_DISP_N - Table size = 7 bytes

| Attribute Name | Attribute ID | Type | Remark | Qual | Example Value |
|---|---|---|---|---|---|
| Metric | MDC_ATTR_METRIC_SPECN | | Describes | M | MDC_METRIC_PULSERATE_DISP_N |
| Specification | | | primary Pulse | | |
| | | | Rate but | | |
| | | | suitable for | | |
| | | | display | | |
| Metric | MDC_ATTR_METRIC_DATALOCN | | Byte offset in | M | 83 |
| Location | | | data block this | | |
| | | | is located | | |

### Attributes for Streaming Pulse Rate—Slow-Acting but Suitable for Display Purposes.

TABLE 12
Metric for PULSERATE_DISP_L

| Attribute Name | Attribute ID | Type | Remark | Qual | Example Value |
|---|---|---|---|---|---|
| Metric | MDC_ATTR_METRIC_SPECN | | Describes slow- | M | MDC_METRIC_PULSERATE_DISP_L |
| Specification | | | acting Pulse | | |
| | | | Rate and | | |
| | | | suitable for | | |
| | | | display | | |
| Metric | MDC_ATTR_METRIC_DATALOCN | | Byte offset in | M | 88 |
| Location | | | data block this | | |
| | | | is located | | |

### Attributes for Streaming Pulse Amplitude

In some embodiments it is useful for a pulse oximeter to express some measure of the pulse quality. The attribute of note is the MD_ATTR_MODE_MSMT, which would allow different vendors to provide their own 2-byte metric measurement value. More data description may be appropriate here, as the two bytes implicitly defined by the MDC_METRIC_PULSE_QUAL attribute may be used as a combination of pulse occurrence status, characterization mnemonics or index numeric.

TABLE 13
Metric for PULSE_QUAL - Table size = 11 bytes

| Attribute Name | Attribute ID | Type | Remark | Qual | Example Value |
|---|---|---|---|---|---|
| Metric | MDC_ATTR_METRIC_SPECN | | Describes | M | MDC_METRIC_PULSE_QUAL |
| Specification | | | Pulse Quality - | | |
| | | | supports | | |
| | | | multiple | | |
| | | | metric | | |
| | | | methods | | |
| Metric | MDC_ATTR_METRIC_DATALOCN | | Byte offset in | M | 93 |
| Location | | | data block | | |
| | | | this is located | | |
| Metric | MDC_ATTR_MODE_MSMT | | What | O | MDC_PQ_METHOD_THRESHOLD |
| measurement | | | algorithm or | | or |
| method | | | method is | | MDC_PQ_METHOD_MOD_PCNT |
| | | | used | | |

### Attributes for Streaming Time-Synchronized Event Reporting

This attribute is the key object for time-synchronized event reporting. The data description, named as MDC_TYPE_EVENTREC, of three bytes may be considered as a combination of an event type such as PULSE_OCCURRED, along with two bytes indicating the millisecond offset at which the event occurred. Note that this makes use of the Metric repeat interval, as there is capacity for two events per data block.

TABLE 14
Metric for EVENT_RECORD: Table size = 10 bytes

| Attribute Name | Attribute ID | Type | Remark | Qual | Example Value |
|---|---|---|---|---|---|
| Metric | MDC_ATTR_METRIC_SPECN | | Describes | M | MDC_METRIC_EVENT_RECORD |
| Specification | | | structure of a | | |
| | | | high-resolution | | |
| | | | time- | | |
| | | | synchronized | | |
| | | | event | | |
| Metric Location | MDC_ATTR_METRIC_DATALOCN | | Byte offset in | M | 47 |
| | | | data block this | | |
| | | | is located | | |
| Metric Repeat | MDC_ATTR_METRIC_DATARPTINTVL | | How often | M | 50 |
| Interval | | | attribute is | | |
| | | | repeated in | | |
| | | | block | | |

### Attributes for Streaming Cyclic Redundancy Check (CRC)

The data block should be protected with minimal overhead. Using a simple CRC16 on the entire block will be sufficient protection for the block.

TABLE 15
Metric for CRC - Table size = 7 bytes

| | | Attribute | | | |
|---|---|---|---|---|---|
| Attribute Name | Attribute ID | Type | Remark | Qual | Example Value |
| Metric | MDC_ATTR_METRIC_SPECN | | | M | MDC_METRIC_CRC |
| Specification | | | | | |
| Metric | MDC_ATTR_METRIC_DATALOCN | | Byte offset | M | 123 |
| Location | | | in data block | | |
| | | | this is | | |
| | | | located | | |

### Attributes for Streaming Command Acknowledgement

A command structure, used for configuration and control of a personal health medical device, need not be excessively complex. It is envisioned that any command sent to such a device, such as a pulse oximeter, would be echoed in a data packet as an acknowledgement of the proper reception and processing of that command. Discussion of the mechanism of commands is outside the scope of this document.

TABLE 16
Metric for CMDACK - Table size = 7 bytes

| Attribute Name | Attribute ID | Type | Remark | Qual | Example Value |
|---|---|---|---|---|---|
| Metric | MDC_ATTR_METRIC_SPECN | | | M | MDC_METRIC_CMDACK |
| Specification | | | | | |
| Metric Location | MDC_ATTR_METRIC_DATALOCN | | Byte offset in | M | 22 |
| | | | data block this is | | |
| | | | located | | |

### Attributes for Streaming Device Alarms

Device-specific alarm information, such as leaving the bounds of SpO₂ pulse rate limits, battery failure, or sensor failure can be described here.

TABLE 17
Metric for ALARMS - Table size = 7 bytes

| Attribute Name | Attribute ID | Type | Remark | Qual | Example Value |
|---|---|---|---|---|---|
| Metric | MDC_ATTR_METRIC_SPECN | | | M | MDC_METRIC_ALARMS |
| Specification | | | | | |
| Metric Location | MDC_ATTR_METRIC_DATALOCN | | Byte offset | M | 27 |
| | | | in data | | |
| | | | block this is | | |
| | | | located | | |

### Attributes for Streaming Device Status

Device-specific status information, such as notification of synchronism within a transport network, may be expressed within a bitmap in this data record.

TABLE 18
Metric for STATUS - Table size = 7 bytes

| | | Attribute | | | |
|---|---|---|---|---|---|
| Attribute Name | Attribute ID | Type | Remark | Qual | Example Value |
| Metric | MDC_ATTR_METRIC_SPECN | | | M | MDC_METRIC_STATUS |
| Specification | | | | | |
| Metric Location | MDC_ATTR_METRIC_DATALOCN | | Byte offset | M | 52 |
| | | | in data | | |
| | | | block this is | | |
| | | | located | | |

### Attributes for Streaming Sensor Connection Information

Information about a sensor can, in some embodiments, be placed in this data record.

TABLE 19
Metric for SNSRCONN - Table size = 7 bytes

| | | Attribute | | | |
|---|---|---|---|---|---|
| Attribute Name | Attribute ID | Type | Remark | Qual | Example Value |
| Metric | MDC_ATTR_METRIC_SPECN | | | M | MDC_METRIC_SNSRCONN |
| Specification | | | | | |
| Metric Location | MDC_ATTR_METRIC_DATALOCN | | Byte offset | M | 72 |
| | | | in data block | | |
| | | | this is | | |
| | | | located | | |

### Attributes for Streaming Sensor Description Information

If desired, additional information about a sensor can, in some embodiments, be placed in this data record.

TABLE 20
Metric for SNSRDESC - Table size = 7 bytes

| | | Attribute | | | |
|---|---|---|---|---|---|
| Attribute Name | Attribute ID | Type | Remark | Qual | Example Value |
| Metric | MDC_ATTR_METRIC_SPECN | | | M | MDC_METRIC_SNSRDESC |
| Specification | | | | | |
| Metric Location | MDC_ATTR_METRIC_DATALOCN | | Byte | M | 77 |
| | | | offset in | | |
| | | | data block | | |
| | | | this is | | |
| | | | located | | |

### Attributes for Streaming Time Reporting

The following two attributes are used for describing where time and data information can be retrieved.

TABLE 21
Metric for TIME - Table size = 7 bytes

| | | Attribute | | | |
|---|---|---|---|---|---|
| Attribute Name | Attribute ID | Type | Remark | Qual | Example Value |
| Metric | MDC_ATTR_METRIC_SPECN | | | M | MDC_METRIC_TIME |
| Specification | | | | | |
| Metric Location | MDC_ATTR_METRIC_DATALOCN | | Byte offset in | M | 17 |
| | | | data block | | |
| | | | this is located | | |

### Attributes for Streaming Date Reporting

TABLE 22
Metric for DATE - Table size = 7 bytes

| | | Attribute | | | |
|---|---|---|---|---|---|
| Attribute Name | Attribute ID | Type | Remark | Qualifier | Example Value |
| Metric | MDC_ATTR_METRIC_SPECN | | | M | MDC_METRIC_DATE |
| Specification | | | | | |
| Metric Location | MDC_ATTR_METRIC_DATALOCN | | Byte offset in | M | 12 |
| | | | data block | | |
| | | | this is located | | |

### Attributes for Streaming Plethysmographic Data Samples

Plethysmographic data is the data type most closely matching a streaming data format. Note here that the attribute is repeated every five bytes in the data block. Refer to the Payload format below to see how this relates.

TABLE 23
Metric for PLETH - Table size = 10 bytes

| | | Attribute | | | |
|---|---|---|---|---|---|
| Attribute Name | Attribute ID | Type | Remark | Qual | Example Value |
| Metric | MDC_ATTR_METRIC_SPECN | | | M | MDC_METRIC_PLETH |
| Specification | | | | | |
| Metric Location | MDC_ATTR_METRIC_DATALOCN | | Byte offset in | M | 0 |
| | | | data block this | | |
| | | | is located | | |
| Metric Repeat | MDC_ATTR_METRIC_DATARPTINTVL | | How often | M | 5 |
| Interval | | | attribute is | | |
| | | | repeated in | | |
| | | | block | | |

### Attributes for Streaming Frame Counter

If desired, a free-running frame counter can be described.

TABLE 24
Metric for Frame Counter - Table size = 7 bytes

| | | Attribute | | | |
|---|---|---|---|---|---|
| Attribute Name | Attribute ID | Type | Remark | Qual | Example Value |
| Metric | MDC_ATTR_METRIC_SPECN | | | M | MDC_METRIC_FRMCNT |
| Specification | | | | | |
| Metric Location | MDC_ATTR_METRIC_DATALOCN | | Byte offset in | M | 3 |
| | | | data block this | | |
| | | | is located | | |

Additional attributes for reporting alarm limit settings for SpO₂ and Pulse Rate, although not included for brevity's sake, are described similarly.

Payload for Streaming SpO₂

A fixed-size data block for streaming data transmission has many advantages. One advantage is that a measurement device generating waveform data need not (and is probably unable to) buffer any of the sample points; they are sent almost immediately after the acquisition is taken. Another advantage to the fixed-block format is that a legacy Manager Device with foreknowledge of the particular data layout need not concern itself with the details of the self-description mechanism: looking for synchronization bytes such as the ones located at offset 2 and 7, as well as looking for frame counters at offset 8 gives the legacy Manager Device reasonable confidence that it is reading data at the correct locations. The few reserved bytes may be used for future development or internal diagnostic use.

In an Advanced Agent Device 110, the payload type P1 in the above example, which is representative of a streaming data format, may appear as the table described using the previous attribute definitions:

TABLE 25

| | 0 | 1 | 2 | 3 | 4 |
|---|---|---|---|---|---|
| Offset | PPG Hi | PPG Lo | Status/Control | MUX DATA 1 | MUX DATA 2 |
| 0 | PPGHi0 | PPGLo0 | 0xFF Sync 1 | CountHi | CountLo |
| 5 | PPGHi1 | PPGLo1 | 0x55 Sync 2 | 0x0\|0x1\|0x2 | Reserved |
| 10 | PPGHi2 | PPGLo2 | Yr | Month | Day |
| 15 | PPGHi3 | PPGLo3 | Hr | Min | Sec |
| 20 | PPGHi4 | PPGLo4 | CmdAckHi | CmdAckLo | Reserved |
| 25 | PPGHi5 | PPGLo5 | AlarmsHi | AlarmsLo | Reserved |
| 30 | PPGHi6 | PPGLo6 | SpO2AlmHi | SpO2-std | SpO2-std frac |
| 35 | PPGHi7 | PPGLo7 | SpO2AlmLo | SpO2-slow | SpO2-std frac |
| 40 | PPGHi8 | PPGLo8 | Reserved | SpO2-fast | SpO2-fast-frac |
| 45 | PPGHi9 | PPGLo9 | Event1Type | Event1HiByte | Event1LoByte |
| 50 | PPGHi10 | PPGLo10 | StatusHi | StatusLo | Reserved |
| 55 | PPGHi11 | PPGLo11 | PlsRtHiAlmMSB | PlsRtHiAlmLSB | PlsRtLoAlmMSB |
| 60 | PPGHi12 | PPGLo12 | PlsRtLoAlmLSB | SpO2-std disp | SpO2-slow disp |
| 65 | PPGHi13 | PPGLo13 | Reserved | SpO2-B-B | SpO2BB-frac |
| 70 | PPGHi14 | PPGLo14 | SnsrConn | PulseRateHi | PulseRateLo |
| 75 | PPGHi15 | PPGLo15 | SnsrDesc | PulseRateSlowHi | PulseRateSlowLo |
| 80 | PPGHi16 | PPGLo16 | Reserved | PulseRate-DispHi | PulseRate-DispLo |
| 85 | PPGHi17 | PPGLo17 | Reserved | PulseRateS-DispHi | PulseRateS-DispLo |
| 90 | PPGHi18 | PPGLo18 | Reserved | PulseQualityHi | PulseQualityLo |
| 95 | PPGHi19 | PPGLo19 | Event2Type | Event2HiByte | Event2LoByte |
| 100 | PPGHi20 | PPGLo20 | Reserved | Reserved | Reserved |
| 105 | PPGHi21 | PPGLo21 | Reserved | Reserved | Reserved |
| 110 | PPGHi22 | PPGLo22 | Reserved | Reserved | Reserved |
| 115 | PPGHi23 | PPGLo23 | Reserved | Reserved | Reserved |
| 120 | PPGHi24 | PPGLo24 | Reserved | CRC16-hi | CRC16-lo |

### Episodic Attributes for a Standard Device

As a device's Standard capabilities are well known in the device specializations, a device only adhering to these requirements need not self-describe. However, the device in some embodiments can self-describe.

### Episodic Attributes for an Advanced Device

When Episodic data is requested, only one type of SpO₂ and Pulse Rate, as well as Pulse Amplitude, Alarms and Status data elements needs to be sent. Note that the byte position has changed in the following tables to reflect their new positioning. The following tables are to be sent if an episodic data format is chosen. These are essentially a subset of the streaming data format with byte position location changed to reflect the smaller packet size.

### Attributes for Advanced Episodic SpO₂

TABLE 26
SpO₂ for Episodic data - Table size = 7 bytes

| Attribute Name | Attribute ID | Type | Remark | Qual | Example Value |
|---|---|---|---|---|---|
| Metric | MDC_ATTR_METRIC_SPECN | | Describes primary | M | MDC_METRIC_O2_SAT_NORM_EP |
| Specification | | | expression of SpO₂ | | |
| Metric | MDC_ATTR_METRIC_DATALOCN | | Byte offset in data | M | 0 |
| Location | | | block this is located | | |

### Attributes for Advanced Episodic Pulse Rate

TABLE 27
Pulse Rate for Episodic data - Table size = 7 bytes

| Attribute | | Attribute | | | |
|---|---|---|---|---|---|
| Name | Attribute ID | Type | Remark | Qual | Example Value |
| Metric | MDC_ATTR_METRIC_SPECN | | Describes primary | M | MDC_METRIC_PULSERATE_N_EP |
| Specification | | | expression of | | |
| | | | Pulse Rate | | |
| Metric | MDC_ATTR_METRIC_DATALOCN | | | M | 2 |
| Location | | | | | |

### Attributes for Advanced Episodic Pulse Amplitude

This table shows

TABLE 28
Pulse Amplitude for Episodic Data - Table size = 7 bytes

| | | Attribute | | | |
|---|---|---|---|---|---|
| Attribute Name | Attribute ID | Type | Remark | Qual | Example Value |
| Metric | MDC_ATTR_METRIC_SPECN | | Describes Pulse | M | MDC_METRIC_PULSEAMP_EP |
| Specification | | | Amplitude | | |
| Metric | MDC_ATTR_METRIC_DATALOCN | | | M | 4 |
| Location | | | | | |

### Attributes for Advanced Episodic Alarms

In table 29, a Metric Specification is presented that implicitly indicates the alarms entity to be a two-byte value. In addition, alarm or status words often have bit-oriented definitions. Several optional examples are provided below: many are single-bit definitions, and one example shows how a three-bit value positioned non-contiguous would be described. If no additional bit-oriented definitions were included, then this table would also be seven bytes. In the worst case, 16 single-bit definitions each using 7 bytes in the table would consume 112 bytes in addition to the base alarms entity.

TABLE 29
Alarms for Episodic data - Table size = 7-119 bytes

| Attribute | | | | | |
|---|---|---|---|---|---|
| Name | Attribute ID | Type | Remark | Qual | Example Value |
| Metric | MDC_ATTR_METRIC_SPECN | | | M | MDC_METRIC_ALARMS_EP |
| Specification | | | | | |
| Metric | MDC_ATTR_METRIC_DATALOCN | | Byte offset in data | M | 6 |
| Location | | | block this is located | | |
| | MDC_METRIC_ALARM_DEFN | | | O | MDC_METRIC_ALARMS_SNSR_DISC |
| Bitfield | MDC_METRIC_BITFLD_BIT | | | O | 0 |
| Position | | | | | |
| | MDC_METRIC_ALARM_DEFN | | | | MDC_METRIC_ALARMS_SNSR_FLT |
| Bitfield | MDC_METRIC_BITFLD_BIT | | | O | 1 |
| Position | | | | | |
| | MDC_METRIC_ALARM_DEFN | | | | MDC_METRIC_ALARMS_ARTIFACT |
| Bitfield | MDC_METRIC_BITFLD_BIT | | | O | 2 |
| Position | | | | | |
| | MDC_METRIC_BITFLD_SIZE | | | O | 1 |
| | MDC_METRIC_ALARM_DEFN | | | O | MDC_METRIC_ALARMS_MOTION |
| Bitfield | MDC_METRIC_BITFLD_BIT | | | O | 3 |
| Position | | | | | |
| | MDC_METRIC_ALARM_DEFN | | | O | MDC_METRIC_ALARMS_BATTLO |
| Bitfield | MDC_METRIC_BITFLD_BIT | | | O | 4 |
| Position | | | | | |
| | MDC_METRIC_ALARM_DEFN | | | O | MDC_METRIC_ALARMS_BATTCRIT |
| Bitfield | MDC_METRIC_BITFLD_BIT | | | O | 5 |
| Position | | | | | |
| | MDC_METRIC_ALARM_DEFN | | | O | MDC_METRIC_ALARMS_DEVFAIL |
| Bitfield | MDC_METRIC_BITFLD_BIT | | | O | 6 |
| Position | | | | | |
| | MDC_METRIC_ALARM_DEFN | | | O | MDC_METRIC_ALARMS_LOPERF |
| Bitfield | MDC_METRIC_BITFLD_BIT | | | O | 7 |
| Position | | | | | |
| | MDC_METRIC_ALARM_DEFN | | | O | MDC_METRIC_ALARMS_SPO2_HI |
| Bitfield | MDC_METRIC_BITFLD_BIT | | | O | 8 |
| Position | | | | | |
| | MDC_METRIC_ALARM_DEFN | | | O | MDC_METRIC_ALARMS_SPO2_LO |
| Bitfield | MDC_METRIC_BITFLD_BIT | | | O | 9 |
| Position | | | | | |
| | MDC_METRIC_ALARM_DEFN | | | O | MDC_METRIC_ALARMS_PLSRT_HI |
| Bitfield | MDC_METRIC_BITFLD_BIT | | | O | 10 |
| Position | | | | | |
| | MDC_METRIC_ALARM_DEFN | | | O | MDC_METRIC_ALARMS_PLSRT_LO |
| Bitfield | MDC_METRIC_BITFLD_BIT | | | O | 11 |
| Position | | | | | |

Any Status information can be expressed in the following table. For brevity, one bit-oriented definition applicable to SpO₂ is included as well as additional multi-bit and single-bit field examples. This status bit indicates that the SpO₂ being delivered has been calculated and processed through every averaging filter to its fullest capability.

TABLE 30
Status for Episodic data - Table size = 7-119 bytes

| Attribute | | Attribute | | | |
|---|---|---|---|---|---|
| Name | Attribute ID | Type | Remark | Qual | Example Value |
| Metric | MDC_ATTR_METRIC_SPECN | | | M | MDC_METRIC_STATUS_EP |
| Specification | | | | | |
| Metric | MDC_ATTR_METRIC_DATALOCN | | Byte | M | 8 |
| Location | | | offset in | | |
| | | | data | | |
| | | | block | | |
| | | | this is | | |
| | | | located | | |
| | MDC_METRIC_STATUS_DEFN | | | O | MDC_METRIC_STATUS_FQSPO2 |
| Bitfield | MDC_METRIC_BITFLD_BIT | | | O | 0 |
| Position | | | | | |
| | MDC_METRIC_STATUS_DEFN | | | O | MDC_METRIC_STATUS_3BITEXMP |
| Bitfield | MDC_METRIC_BITFLD_BIT | | | O | 1 |
| Position | | | | | |
| | MDC_METRIC_BITFLD_WIDTH | | | O | 3 |
| | MDC_METRIC_STATUS_DEFN | | | | MDC_METRIC_STATUS_EXMP2 |
| Bitfield | MDC_METRIC_BITFLD_BIT | | | | 4 |
| Position | | | | | |

### Size of Episodic Header

Assuming every alarm and status bit is defined uniquely, it would take 348 bytes to transmit the full description. If the alarms and status are sparsely populated, fewer bytes would be needed to send the full description.

TABLE 31

| | | Size of fixed- | Number of | | Size of |
|---|---|---|---|---|---|
| | Number of fixed- | size data | variable-size | Size of variable- | description |
| Case | size tables | element tables | tables | size tables | header |
| Worst | 3 | 7 | 2 | 119 | 21 + 238 = 259 bytes |
| Moderate | 3 | 7 | 2 | 63* | 21 + 126 = 147 bytes |

*based on 8 single bit definitions each consuming 7 bytes to describe

### Payload for Episodic SpO₂

The payload for type P2 in the example, the episodic format may appear as follows:

TABLE 32

| Byte Offset | Meaning |
|---|---|
| 0 | SpO2 - int |
| 1 | SpO2 - frac |
| 2 | PulseRateHi |
| 3 | PulseRateLo |
| 4 | PulseAmpHi |
| 5 | PulseAmpLo |
| 6 | AlarmsHi |
| 7 | AlarmsLo |
| 8 | StatusHi |
| 9 | StatusLo |

### Messaging Format

The messaging scheme of the present invention is intended to be simple enough for computer-bound devices to implement, yet flexible enough to allow two-way communication, and error checking to prevent an Agent Device 110 from sending a legal but malformed payload to the Manager Device 130.

In one embodiment there are five packet types. These five packet types include, Connect (CNC), Classify (CLS), Communicate (COM), Confirm (CFM), and Control (CTL). These packet types are intended to align with the “Data flow interactions” discussed earlier in the document. A packet format, according to one embodiment, includes a header block, payload and optional CRC block. The header block consists of two bytes with fields describing Packet Type, Packet Length, and several flags.

In one embodiment the message format includes a number of valid TYPE fields. These valid TYPE fields include 3′b001—CNC, 3′b010—CLS, 3′b011—COM, 3′b100 —CTL, and 3′b101—CFM. In some embodiments the RSVD bit must be set to 1′b0.

The CRC bit is set if a particular packet has the optional Cyclic Redundancy Checking enabled. In one embodiment, only one type of CRC method (such CRC16) is allowed, and these bytes are be included in the LEN field

In one embodiment the ACK bit is set if a confirmation packet is required. The packet is not allowed to have this bit set if the TYPE is set to 3′b101 (CFM). However, in other embodiments, a CFM packet can use this bit. A CFM packet with the ACK bit set typically means that the preceding packet received a proper reply and a CFM packet with the ACK bit clear can be synonymous with a NOACK.

The LEN field declares how many bytes follow this header. In some embodiments the LEN values can range from 0 to 1023.

### Connect Packet Type:

As discussed above, an Agent Device 110 sends a CNC packet to the Manager Device 130. In one embodiment there are three types of connection transactions that can transpire. These connection transactions can include where an Agent Device 110 wants to connect to whatever Manager Device 130 is available, and has never communicated with a Manager Device (has no transaction ID) (INTRO subtype), where an Agent Device 110 wants to connect with the last known Manager Device, and has a transaction ID (HAVE_ID subtype), or where an Agent Device 110 has transaction ID, but wants to give up trying to communicate with last known Manager Device 130, or wants to start over with a new Manager Device. In some embodiments there is a distinction between an Agent Device 110 wanting to communicate with same Manager Device due to long communication timeout vs. an Agent Device 110 wanting to start a new conversation or connection.

Information in the initial CNC packet should also include the level of protocol supported by the Agent Device 110.

If during the connection the Manager Device 130 responds with a Transaction ID matching the one held by the Agent Device, the previously sent (or the default) may be sent.

Conversely a Manager Device 130 can send a CNC packet, when it wants to wake an Agent Device for once-a-day reading. However, other time periods can be used such as one an hour or every thirty minutes. The Agent Device 110 then needs to respond with the correct Transaction ID for the payload to be sent.

Many of the message types include state transitions. These state transitions are expressed as subfields, placed at the beginning of the payload block. This is to keep the basic data format as simple as possible.

### Classify Packet Type:

This is where the query for further identification and possible subsequent self-description takes place. As with the CNC packet type, the beginning of the payload would contain a subtype field applicable to each stage of classification. Two examples of these classifications are:

REQ_CLASS (Manager Device->Agent Device)

RSP_CLASS (Agent Device->Manager Device)

If Agent Device 110 is a multifunction device, it may need to respond with multiple RSP_CLASS messages. These classifications could use CFM packets of the variety that can report Protocol Errors. However, other packet types can be used.

### Communicate Packet Type:

Data payloads containing physiological information are sent with this packet type. As with the CNC and CLS packet types, the beginning of the payload would contain a subtype field declaring which type of payload (based on what is claimed during the Classify stage) is being sent.

### Control Packet Type:

This packet can be used for several purposes. For example this packet can be used for the Agent Device to asynchronously alert the Manager Device that a power failure is imminent, for the Agent Device to alert the Manager Device that a user reconfigured alarm settings directly with control buttons on the Agent Device. The Manager Device 130 may also initiate this transaction type to programmatically reconfigure the Agent Device to respond for example to new alarm settings. The control packet can also be used to start and stop Communicate packets, as well as to negotiate Quality of Service (QoS).

### Confirm Packet Type:

In one embodiment, the CFM packet can take on two forms. The first form is as an ACK/NOACK or to inform initiator of a Protocol or CRC error. The ACK/NOACK format can consist only of the header block (LEN field may be 0). Otherwise, the Confirm packet may place a return status using 11073-10101 Nomenclature terms (from the Communication package) describing the failure, like MDC_CC_COMM_ERROR or MDC_CC_CRC_ERROR.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a portable agent device adapted for use within a personal health space, said agent device obtaining physiological data associated with a patient, and said agent device operational within one or more frameworks; and
a manager device in communication with the agent device to receive said physiological data, said manager device processing the physiological data for presentation to the patient or transmission to another device, and said manager device being configurable in response to queries to and from said agent device.

2. The system of claim 1 wherein said one or more frameworks include a standard framework and an advanced framework.

3. The system of claim 1 wherein the communication between said agent device and manager device is via a wired or wireless connection.

4. The system of claim 1 wherein the manager device is configurable based on the level of complexity of the agent device.

5. The system of claim 1 wherein the agent device further obtains activity information related to the patient.

6. A system for personal health data transmission comprising:
a plurality of agent devices, each adapted to obtain physiological data from a patient within a personal health care space, said multiple agent devices including standard agent devices and advanced agent devices, said standard agent devices having limited data collection capabilities relative to said advanced agent devices; and
a plurality of manager devices, each adapted to receive said physiological data from one or more of said plurality of agent devices, said plurality of manager devices including standard manager devices and advanced manager devices, said standard manager devices having limited data communication capabilities relative to the advanced manager devices.

7. The system of claim 6 wherein standard payloads are supported by standard agent devices and rely on device/data specialization to specify the numerics and the format of the payload structure.

8. The system of claim 7 wherein the numerics include SP02 and heartrate from a pulse oximeter.

9. The system of claim 7 wherein advanced payloads include payloads in addition to said standard payloads.

10. The system of claim 9 wherein advanced payloads are supported by self-descriptors that allow one or more of the plurality of manager devices to parse information within the advanced payloads.

11. A system for personal health data transmission comprising:
a standard agent device adapted for use within a personal health space, said standard agent device obtaining physiological data associated with a patient; and
a manager device including a description of said standard agent device prior to a communication of said physiological data to said manager device, said description including data transmission information relating to said standard agent device to facilitate said communication.

12. The system of claim 11 wherein said manager device processing the physiological data for presentation to the patient or transmission to another device.

13. The system of claim 11 wherein said manager device also communicates to a advanced agent.

14. The system of claim 13 wherein the advanced agent device is capable of self-description prior to a data transmission.

15. The system of claim 14 wherein the manager device is configurable in response to queries to and from said advanced agent device.

16. The system of claim 13 wherein a self-descriptor is sent from the advanced agent device to the manager device in order for the manager device to determine how to process the subsequent data stream.

17. The system of claim 16 wherein the self-descriptor includes a device description

18. The system of claim 16 wherein the self-descriptor includes a payload description.

19. The system of claim 18 wherein the payload description includes payload size information.

20. A system for personal health data transmission comprising:
a plurality of agent devices adapted for use within a personal health space, and each of said plurality of agent devices obtaining physiological data associated with a patient; and
a plurality of manager devices, each adapted to receive said physiological data from one or more of said plurality of agent devices, with said plurality of agent devices and said plurality of manager devices operational within a defined framework including a standardized framework and an advanced framework, with said standardized framework defined by a minimum set of numerics and formats for data transmission, said manager devices adapted to communicate with agent devices operating within the standardized format without the need of self-description.

21. The system of claim 20 wherein advanced agent devices self-describe capabilities to one or more of the plurality of manager devices.

22. The system of claim 20 wherein advanced agent devices communicate data in addition to standardized data communicated by a standardized agent device.

23. The system of claim 20 wherein manager devices within the advanced framework include capabilities in addition to capabilities of manager devices within the standardized framework.

24. The system of claim 23 wherein the manager devices within the advanced framework are capable of differentiation of agent devices.
